(19) United States
(12) Patent Application Publication
(10) Pub. No.: US 2024/0296819 A1
(43) Pub. Date: Sep. 5, 2024

(54) URETHANE FOAM INSULATOR

(71) Applicant: PARKER CORPORATION, Tokyo (JP)

(72) Inventors: Tsuyoshi YAMASHITA, Tokyo (JP); Ryoji SAKANE, Tokyo (JP); Tetsuya OZAKI, Tokyo (JP); Takahiro KANAI, Tokyo (JP); Naoyuki NAKAIZUMI, Tokyo (JP); Syoji MIYAHARA, Tokyo (JP)

(73) Assignee: PARKER CORPORATION, Tokyo (JP)

(21) Appl. No.: 18/573,088

(22) PCT Filed: Jun. 30, 2022
(86) PCT No.: PCT/JP2022/026231

§ 371 Date: Dec. 21, 2023

(30) Foreign Application Priority Data
Jul. 12, 2021 (JP) 2021-114957

(51) Int. Cl. G10K 11/162; B60R 13/08

(52) U.S. Cl. CPC G10K 11/162; B60R 13/08

(57) ABSTRACT

[Problem] To realize, by means of a simple structure, a soundproofing material having a soundproofing property equal or superior to that of a conventional one against sound including noise arising from vibration generated by a panel (dash panel) that separates the inside and outside of a vehicle cabin or an automotive component and penetrating into the vehicle cabin, and further to realize an excellent soundproofing property in a method for attaching an automotive component using the soundproofing material.

[Solution] An automotive soundproofing material made of a urethane foam material, characterized in that the urethane foam material has a single-layer structure, the urethane foam material is configured to have either a uniform thickness or an increased thickness only in a region where it is needed, and an automotive component can be installed while compressing the urethane foam material.

### TECHNICAL FIELD

The present invention relates to an insulator made of a urethane foam material, and particularly relates to a soundproofing material used for an automotive dash insulator.

### BACKGROUND ART

Conventionally, for example, a soundproofing material for preventing noise in an engine room from propagating into a vehicle cabin is placed inside of a vehicle cabin on a panel (dash panel) that separates the engine room from the inside of the vehicle cabin. As a material for the soundproofing material, a fiber structure or a foam that has flexibility capable of following fine unevenness of a vehicle body panel and contains many voids is suitable. This type of soundproofing material exhibits a sound absorbing effect of capturing sound waves in the voids and damping the sound waves, and also exhibits a sound insulating effect of preventing sound waves from penetrating into the vehicle cabin by reflecting the sound waves.

For example, in order to prevent noise from penetrating into a vehicle cabin, a soundproofing material called a dash insulator is placed on a panel (dash panel) that separates the inside of a vehicle cabin from an engine room. However, there is a problem that engine noise that penetrates into the vehicle cabin through the panel (dash panel) that separates the inside and outside of the vehicle cabin from the engine room, or noise such as radiated sound arising from vibration of the panel (dash panel) or a floor panel that separates the inside and outside of the vehicle cabin, or an automotive component such as an air conditioning unit (HVAC) installed cannot be sufficiently prevented by a conventional soundproofing material used for a dash insulator.

PTL 1 discloses a soundproofing material obtained by stacking a first sound absorbing layer made of urethane foam or the like and a second sound absorbing layer similarly made of urethane foam or the like, and interposing a sound insulating layer made of a thermoplastic resin film or the like at the interface between these sound absorbing layers.

For example, when the soundproofing material having such a configuration is used as a soundproofing material for a vehicle, noise outside a vehicle cabin is absorbed by the first sound absorbing layer, and also the noise outside the vehicle cabin can be insulated by the sound insulating layer. In addition, noise inside the vehicle cabin is absorbed by the second sound absorbing layer, so that a quiet vehicle cabin can be realized.

However, it has a three-layer structure, and therefore has a disadvantage that the production method is complicated.

PTL 2 discloses a soundproofing material, in which a sound absorbing layer is formed of a foamed resin-based sound absorbing layer such as polyurethane foam and a fiber-based sound absorbing layer such as a felt, and a sound insulating layer obtained by combining a foamed resin and a fiber is formed at the interface between these sound absorbing layers.

With such a configuration, it is possible to obtain a soundproofing material having an excellent sound absorbing property and an excellent sound insulating property by means of a simple structure and a simple production method.

However, part of noise that penetrates into a vehicle cabin arises from vibration generated by a panel (dash panel) that separates the inside and outside of a vehicle cabin or automotive an component, and sufficient consideration has not been given to prevention of the vibration of a panel (dash panel) that separates the inside and outside of a vehicle cabin or an automotive component.

In addition, in the case of a felt, a reaction force during compression is large, and if the layer is thickened in order to enhance the soundproofing performance, there is a problem that an automotive component cannot be attached. Further, in the case of a felt, since the elastic modulus is increased by compression, there is a problem that the sound insulation performance deteriorates.

PTL 3 discloses that by attaching an automotive component in a panel (dash panel) that separates the inside and outside of a vehicle cabin while sandwiching a sound absorbing material between the panel (dash panel) that separates the inside and outside of a vehicle cabin and the automotive component, a good attachment property of the automotive component is ensured, and vibration of the automotive component or the panel can be prevented.

However, the sound absorbing material sandwiched between the panel (dash panel) that separates the inside and outside of a vehicle cabin and the automotive component is sandwiched only with a portion (attachment position) of the automotive component, and therefore, there are still many gaps between the panel (dash panel) that separates the inside and outside of a vehicle cabin and the automotive component, and vibration generated by the panel (dash panel) that separates the inside and outside of a vehicle cabin or the automotive component and noise arising from vibration are not sufficiently prevented.

Further, PTL 4 discloses that by placing an automotive component and a sound absorbing material so that a surface having a concave portion of the automotive component and a convex portion of the sound absorbing material are in contact with each other, the degree of close contact between the automotive component and the sound absorbing material is improved, and the gap between the automotive component and the sound absorbing material can be filled up, so that sound leakage into the vehicle cabin can be reduced.

However, this cannot be applied to an automotive component that does not have a concave portion on the surface, and it is necessary to pre-shape a convex portion with a shape that matches the concave portion of the automotive component to be placed at a position where the automotive component is planned to be placed in the sound absorbing material, and therefore, it has a disadvantage that the workability is poor.

### CITATION LIST

### Patent Literature

PTL 1: JP2001-347900A

PTL 2: JP2009-226675A

PTL 3: JP2017-7626A

PTL 4: JP2017-9975A

### SUMMARY OF INVENTION

### Technical Problem

Therefore, an object of the invention is to realize, by means of a simple structure, a soundproofing material having a soundproofing property equal or superior to that of a conventional one against sound including noise arising from vibration generated by a panel (dash panel) that separates the inside and outside of a vehicle cabin or an automotive component such as an air conditioning unit (HVAC) and penetrating into the vehicle cabin, and further to realize an excellent soundproofing property in a method for attaching an automotive component using the soundproofing material.

### Solution to Problem

As a result of intensive studies to solve the above problems, a soundproofing material used for an automotive dash insulator of the invention is an automotive soundproofing material having the following characteristics, and a method for attaching an automotive component is a method for attaching an automotive component using the automotive soundproofing material capable of realizing an excellent soundproofing property.
(1) An automotive soundproofing material made of a urethane foam material, characterized in that the urethane foam material has a single-layer structure, the urethane foam material is configured to have either a uniform thickness or an increased thickness only in a region where it is needed, and an automotive component can be installed while compressing the urethane foam material.
(2) The automotive soundproofing material according to the above (1), characterized in that by compressing the urethane foam material while installing the automotive component, an elastic modulus of the urethane foam material is reduced and sound insulation performance is improved.
(3) The automotive soundproofing material according to either one of the above (1) and (2), characterized in that the thickness of the urethane foam material is compressed within a range where a compression ratio is 10% or more and 50% or less.
(4) The automotive soundproofing material according to any of the above (1) to (3), characterized in that only a portion where the automotive component is installed is compressed.
(5) The automotive soundproofing material according to any of the above (1) to (4), characterized in that sound absorption performance at low frequencies is improved.
(6) The automotive soundproofing material according to any of the above (1) to (4), characterized in that vibration damping performance is improved and radiated sound is reduced.
(7) The automotive soundproofing material according to any of the above (1) to (4), characterized in that sound leaking from a hole or a gap for allowing a wire of the automotive component or a pipe to pass therethrough can be blocked by compressing the urethane foam material when the automotive component is installed.
(8) The automotive soundproofing material according to any of the above (1) to (7), characterized in that the urethane foam material has a density of 40 to 120 Kg/m³ and a compressive stress of 1 to 10 KPa.
(9) A method for attaching an automotive component, characterized in that after an automotive soundproofing material made of a urethane foam material is installed in a panel that separates inside and outside of a vehicle cabin, an automotive component installation portion of the urethane foam material is compressed, and thereafter, an automotive component is installed while being in close contact with (compressed against) the urethane foam material.
(10) A method for attaching an automotive component, characterized in that an automotive soundproofing material made of a urethane foam material is installed in a panel that separates inside and outside of a vehicle cabin, and subsequently, an automotive component is installed while compressing the urethane foam material by the automotive component.
(11) The method for attaching an automotive component according to either one of the above (9) and (10), characterized in that the urethane foam material has a single-layer structure, and is configured to have either a uniform thickness or an increased thickness only in a region where it is needed.
(12) The method for attaching an automotive component according to any of the above (9) to (11), characterized in that the panel that separates inside and outside of a vehicle cabin and the automotive soundproofing material made of the urethane foam material are in close contact with each other, and the automotive soundproofing material made of the urethane foam material and the automotive component when the automotive component is installed are in close contact with each other.
(13) The method for attaching an automotive component according to any of the above (9) to (12), characterized in that sound insulation performance is improved.

### Advantageous Effects of Invention

A soundproofing material having a soundproofing property equal or superior to that of a conventional one against sound including noise arising from vibration generated by a panel (dash panel) that separates the inside and outside of a vehicle cabin or an automotive component such as an air conditioning unit (HVAC) and penetrating into the vehicle cabin is realized by means of a simple structure, and an excellent soundproofing property can be realized in a method for attaching an automotive component using the soundproofing material.

### BRIEF DESCRIPTION OF DRAWINGS

FIG. 1 is a characteristic diagram showing test results of a sound absorption performance test of a urethane foam material of the invention and a material equivalent to a current product.

FIG. 2 is a characteristic diagram showing measurement results of a sound insulation performance effect due to compression of a urethane foam material of the invention.

FIG. 3 is a characteristic diagram showing measurement results of a compressive stress due to a difference in density of a urethane foam material of the invention.

FIG. 4 is a characteristic diagram showing measurement results of a compressive stress due to a difference in thickness before compression of a urethane foam material of the invention.

FIG. 5 is a characteristic diagram showing measurement results of a compressive elastic modulus of a urethane foam material of the invention and a comparative example.

FIG. 6 is a characteristic diagram showing test results for a dash panel (inside a vehicle cabin) of an excitation test of an example of the invention and a comparative example.

FIG. 7 is a characteristic diagram showing test results for an air conditioning unit (HVAC) of an excitation test of an example of the invention and a comparative example.

### DESCRIPTION OF EMBODIMENTS

Hereinafter, an embodiment according to the invention will be described. However, the constituent elements described in the following embodiment are examples, and are not intended to limit the technical scope of the invention only thereto.

A urethane foam material used for an automotive soundproofing material of the invention is not particularly limited as long as an automotive component such as an air conditioning unit (HVAC) can be installed while compressing the urethane foam material, but is preferably a soft polyurethane foam. In addition, it is preferably one in which the elastic modulus of the urethane foam material is reduced to improve sound insulation performance by compression, and is more preferably one having excellent sound absorption performance in a low frequency region (1 kHz or less).

The urethane foam material used for the automotive soundproofing material of the invention is produced by reacting a polyol and a polyisocyanate in the presence of a foaming agent, and each component will be described in detail below.

### Polyol

Examples of the polyol according to an embodiment of the invention include low molecular weight polyols such as ethylene glycol (EG), diethylene glycol, propylene glycol (PG), dipropylene glycol, (1,3-or 1,4-) butanediol, pentanediol, neopentyl glycol, hexanediol, cyclohexanedimethanol, glycerin, trimethylolpropane (TMP), 1,2,5-hexanetriol, and pentaerythritol; polyether polyols such as polyethylene glycol, polypropylene glycol (PPG), polypropylenetriol, ethylene oxide/propylene oxide copolymers, polytetramethylene glycol (PTMG), polytetraethylene glycol, and sorbitol-based polyols; acrylic polyols; polybutadiene polyols; polymer polyols having a carbon-carbon bond in a main chain skeleton such as hydrogenated polybutadiene polyol.

Further, one derived from any of the above-mentioned polyhydric alcohols may be used.

Among these polyols, one type may be used alone, or two or more types may be used in combination.

### Polyisocyanate

Examples of the polyisocyanate according to an embodiment of the invention include aliphatic polyisocyanates such as hexamethylene diisocyanate (HDI), trimethylhexamethylene diisocyanate (TMHDI), lysine diisocyanate, and norbornane diisocyanate (NBDI); aromatic polyisocyanates such as TDI (for example, 2,4-tolylene diisocyanate (2,4-TDI), 2,6-tolylene diisocyanate (2,6-TDI)), MDI (for example, 4,4′-diphenylmethane diisocyanate (4,4′-MDI), and 2,4′-diphenylmethane diisocyanate (2,4′-MDI)), 1,4-phenylene diisocyanate, polymethylene polyphenylene polyisocyanate, xylylene diisocyanate (XDI), tetramethylxylylene diisocyanate (TMXDI), tolidine diisocyanate (TODI), 1,5-naphthalene diisocyanate (NDI), and triphenylmethane triisocyanate; and alicyclic polyisocyanates such as trans-cyclohexane-1,4-diisocyanate, isophorone diisocyanate (IPDI), bis(isocyanatomethyl)cyclohexane (H6XDI), and dicyclohexylmethane diisocyanate (H12MDI).

Among these polyisocyanates, one type may be used alone, or two or more types may be used in combination.

### Foaming Agent

As the foaming agent according to an embodiment of the invention, water, an inert gas, or the like is used. Examples of the inert gas include air, nitrogen, and carbon dioxide.

### Another Additive

As another additive according to an embodiment of the invention, a catalyst can be used when the polyol and the polyisocyanate are reacted with each other. Examples of the catalyst include an amine compound and an organometallic compound.

Specific examples of the amine compound include N,N-dimethylaminoethoxyethoxyethanol, N,N-dimethylamino-6-hexanol, N,N-dimethylaminoethoxyethanol, a compound in which 2 mol of ethylene oxide is added to N,N-dimethylaminoethoxyethanol, 5-(N,N-dimethyl)amino-3-methyl-1-pentanol, triethylenediamine, bis(2-dimethylaminoethyl)ether, and N,N,N′,N′-tetramethylhexamethylenediamine.

Examples of the organometallic compound include an organotin compound, an organobismuth compound, an organolead compound, and an organozinc compound. Specific examples thereof include di-n-butyltin oxide, di-n-butyltin dilaurate, di-n-butyltin diacetate, di-n-octyltin oxide, di-n-octyltin dilaurate, monobutyltin trichloride, di-n-butyltin dialkyl mercaptan, and di-n-octyltin dialkyl mercaptan.

Further, a foam stabilizer for forming good bubbles can be used in many cases, and specific examples thereof include a silicone-based foam stabilizer and a fluorine-containing compound-based foam stabilizer. Other than these, an emulsifier; an anti-aging agent such as an antioxidant or an ultraviolet absorber; a filler such as calcium carbonate or barium sulfate; known various additives such as a plasticizer, a colorant, a flame retardant, an antifungal agent, and a foam breaker; or an auxiliary agent can be optionally used as needed.

The urethane foam material used for the automotive soundproofing material of the invention has a single-layer structure which is a simple structure, so that it is easy to produce. Therefore, it is easy to make the thickness uniform, or to thicken only a portion where it is needed, for example, a portion where an automotive component such as an air conditioning unit (HVAC) is (planned to be) installed in a panel (dash panel) that separates the inside and outside of a vehicle cabin.

By thickening a portion where an automotive component is planned to be installed in a panel (dash panel) that separates the inside and outside of a vehicle cabin, it is possible to close a space (gap) between the installed automotive component and the panel (dash panel) that separates the inside and outside of a vehicle cabin. By eliminating the space (gap) between the installed automotive component and the panel (dash panel) that separates the inside and outside of a vehicle cabin, it is possible to prevent radiated sound arising from vibration of the panel (dash panel) that separates the inside and outside of a vehicle cabin or the installed automotive component from penetrating into the vehicle cabin through the space (gap) therebetween. In this case, by thickening the surface, as entirely as possible, of a portion where the automotive component is planned to be installed, the automotive soundproofing material made of a urethane foam material of the invention and the panel (dash panel) that separates the inside and outside of a vehicle cabin, and/or the automotive component when the automotive component is installed come into close contact with each other, and the space between the installed automotive component and the panel (dash panel) that separates the inside and outside of a vehicle cabin can be closed, and by eliminating the space (gap), radiated sound arising from vibration of the automotive component can be more effectively prevented from penetrating into the vehicle cabin through the space (gap), and therefore, this configuration is desirable.

Since the urethane foam material used for the automotive soundproofing material of the invention has a low reaction force when being compressed, it is easy to install an automotive component such as an air conditioning unit (HVAC) while compressing the urethane foam material.

Moreover, the elastic modulus of the urethane foam material is reduced by compression, and the sound insulation performance is improved.

The compression ratio when the urethane foam material is compressed is preferably set in a range of 10% or more and 50% or less.

If the compression ratio exceeds 50%, the reaction force when the urethane foam material is compressed becomes high, which makes it difficult to attach an automotive component while compressing the urethane foam material.

If the compression ratio is less than 10%, the effect of reducing the elastic modulus resulting from compression cannot be obtained, and therefore, improvement of the sound insulation performance due to the reduction in elastic modulus cannot be expected.

The total density of the urethane foam material used for the automotive soundproofing material of the invention is preferably within a range of 40 kg/m³ to 120 kg/m³.

If the density of the urethane foam material is high, the reaction force when it is compressed becomes high, which makes it difficult to attach an automotive component while compressing the urethane foam material.

Further, the compressive stress of the urethane foam material used for the automotive soundproofing material of the invention is preferably within a range of 1 KPa to 10 KPa.

If the compressive stress increases, the reaction force when the urethane foam material is compressed becomes high, which makes it difficult to attach an automotive component while compressing the urethane foam material.

Since the urethane foam material used for the automotive soundproofing material of the invention has a low reaction force when being compressed, an automotive component such as an air conditioning unit (HVAC) can be installed while compressing the urethane foam material.

Since the urethane foam material is sandwiched between a panel (dash panel) that separates the inside and outside of a vehicle cabin and an automotive component to be installed, and the automotive component is installed while compressing the urethane foam material, the entire side surface on the dash panel side of the automotive component to be installed comes into contact with the compressed urethane foam material. Therefore, it is possible to prevent not only vibration of the dash panel but also vibration itself of the installed automotive component. As a result, radiated sound generated due to vibration is also reduced. In this case, it is effective and desirable for reducing the generated radiated sound to sandwich the side surface, as entirely as possible, on the dash panel side of the automotive component to be installed with the urethane foam material.

Further, since the automotive component is installed in the panel (dash panel) that separates the inside and outside of a vehicle cabin by sandwiching the urethane foam material, the structure is a so-called sandwich structure, and the sound insulation performance is further improved.

When the urethane foam material used for the automotive soundproofing material of the invention is sandwiched between the panel (dash panel) that separates the inside and outside of a vehicle cabin and the automotive component to be installed, and the automotive component is installed while compressing the urethane foam material, a hole or a space (gap) for allowing a wire of the automotive component or a pipe or the like to pass therethrough provided in the panel (dash panel) that separates the inside and outside of a vehicle cabin is closed with the compressed urethane foam material. Therefore, an effect capable of blocking sound leaking from the hole or the space (gap) for allowing a wire of the automotive component or a pipe or the like to pass therethrough provided in the panel (dash panel) that separates the inside and outside of a vehicle cabin can be achieved.

The method for attaching an automotive component of the invention is characterized in that the automotive soundproofing material made of a urethane foam material of the invention is installed in a panel (dash panel) that separates the inside and outside of a vehicle cabin, and a portion of the urethane foam material where an automotive component such as an air conditioning unit (HVAC) is planned to be installed (preferably the entire surface of the installation planned portion) is compressed, and thereafter, the automotive component such as an air conditioning unit (HVAC) is installed while being in close contact with the urethane foam material.

Further, the method for attaching an automotive component of the invention is characterized in that the automotive soundproofing material made of a urethane foam material of the invention is installed in a panel (dash panel) that separates the inside and outside of a vehicle cabin, and a portion of the urethane foam material where an automotive component such as an air conditioning unit (HVAC) is planned to be installed (preferably the entire surface of the installation planned portion) is compressed, and thereafter, the automotive component such as an air conditioning unit (HVAC) is installed while further compressing the urethane foam material by the automotive component such as an air conditioning unit (HVAC).

Further, the method for attaching an automotive component of the invention is characterized in that the automotive soundproofing material made of a urethane foam material of the invention is installed in a panel (dash panel) that separates the inside and outside of a vehicle cabin, and subsequently, an automotive component such as an air conditioning unit (HVAC) is installed while compressing the urethane foam material by the automotive component such as an air conditioning unit (HVAC).

The automotive soundproofing material made of a urethane foam material of the invention has a single-layer structure which is a simple structure, so that it is easy to produce, and it is also easy to make the thickness uniform, or to thicken only a portion where it is needed, for example, a portion where an automotive component such as an air conditioning unit (HVAC) is planned to be installed.

By thickening a portion where an automotive component is planned to be installed, the panel that separates the inside and outside of a vehicle cabin and the automotive soundproofing material made of a urethane foam material of the invention come into closer contact with each other. Further, the automotive soundproofing material made of a urethane foam material of the invention and the automotive component when the automotive component is installed come into closer contact with each other. Therefore, a space (gap) between the installed automotive component and the panel (dash panel) that separates the inside and outside of a vehicle cabin can be completely closed with the automotive soundproofing material made of a urethane foam material of the invention, so that radiated sound arising from vibration of the panel (dash panel) that separates the inside and outside of a vehicle cabin or the installed automotive component such as an air conditioning unit (HVAC) can be prevented from penetrating into the vehicle cabin through the space (gap). In this case, by thickening the surface, as entirely as possible, of a portion where the automotive component is planned to be installed, the automotive soundproofing material made of a urethane foam material of the invention and the panel (dash panel) that separates the inside and outside of a vehicle cabin, and/or the automotive component when the automotive component is installed come into closer contact with each other. Accordingly, radiated sound arising from vibration of the automotive component can be more effectively prevented from penetrating into the vehicle cabin through the space (gap), and therefore, this configuration is desirable.

Since the automotive component is installed by compressing the urethane foam material of the invention, the elastic modulus of the urethane foam material of the invention is reduced, and the sound insulation performance is improved.

The compression ratio when the urethane foam material of the invention is compressed is preferably set in a range of 10% or more and 50% or less.

If the compression ratio exceeds 50%, the reaction force when it is compressed becomes high, which makes it difficult to attach an automotive component while compressing the urethane foam material.

If the compression ratio is less than 10%, the effect of reducing the elastic modulus resulting from compression cannot be obtained, and therefore, improvement of the sound insulation performance due to the reduction in elastic modulus cannot be expected.

The total density of the urethane foam material of the invention is preferably within a range of 40 kg/m³ to 120 kg/m³.

If the density of the urethane foam material is high, the reaction force when it is compressed becomes high, which makes it difficult to attach an automotive component while compressing the urethane foam material.

The compressive stress of the urethane foam material of the invention is preferably within a range of 1 KPa to 10 KPa.

If the compressive stress increases, the reaction force when the urethane foam material is compressed becomes high, which makes it difficult to attach an automotive component while compressing the urethane foam material.

In the method for attaching an automotive component of the invention, an automotive component such as an air conditioning unit (HVAC) can be installed while compressing the urethane foam material because the reaction force when the urethane foam material of the invention is compressed is low.

Since the urethane foam material of the invention is sandwiched between the panel (dash panel) that separates the inside and outside of a vehicle cabin and the automotive component to be installed, and the automotive component is installed while compressing the urethane foam material of the invention, the entire side surface of the automotive component to be installed on the side of the panel (dash panel) that separates the inside and outside of a vehicle cabin comes into close contact with the compressed urethane foam material of the invention. Therefore, it is possible to prevent not only vibration of the panel (dash panel) that separates the inside and outside of a vehicle cabin but also vibration itself of the installed automotive component. As a result, radiated sound generated due to vibration is also reduced. In this case, it is effective and desirable for reducing the generated radiated sound to sandwich the side surface, as entirely as possible, on the dash panel side of the automotive component to be installed with the urethane foam material.

Further, since the automotive component is installed in the panel (dash panel) that separates the inside and outside of a vehicle cabin by sandwiching the urethane foam material of the invention, the structure is a so-called sandwich structure, and the sound insulation performance is further improved.

In the method for attaching an automotive component of the invention, when the urethane foam material of the invention is sandwiched between the panel (dash panel) that separates the inside and outside of a vehicle cabin and the automotive component to be installed, and the automotive component is installed while compressing the urethane foam material of the invention, a hole or a space (gap) for allowing a wire of the automotive component or a pipe or the like to pass therethrough provided in the panel (dash panel) that separates the inside and outside of a vehicle cabin is closed with the compressed urethane foam material of the invention. Therefore, an effect capable of blocking sound leaking from the hole or the space (gap) for allowing a wire of the automotive component or a pipe or the like to pass therethrough provided in the panel (dash panel) that separates the inside and outside of a vehicle cabin can be achieved.

### Examples

Hereinafter, the invention will be specifically described with reference to Examples. However, the invention is not limited thereto.

### Sound Absorption Performance Test

The random incident sound absorption coefficient (sound absorption coefficient by reverberation room method) when sound is incident on the surface of a material from all directions with an equal probability was determined from a change in reverberation time between when a sample is installed in the floor of a reverberation room, which is a diffuse sound field, and when the room is empty using the following relational formulae.

According to W. C. Sabine's theory, a reverberation time (T2) when the room is empty can be determined by the following formula (1) from the volume of the reverberation room (V), the speed of sound (c), and the indoor sound absorbing power (A) when the room is empty.

$$T 2 = 55.3 V / ch \qquad ( 1 )$$

Similarly, a reverberation time (T1) when a sample is placed on the floor can be determined by the following formula (2) from the sample's sound absorbing power (ΔA).

$$T 1 = 5 5.3 V / c ( A + Δ A ) \qquad ( 2 )$$

From the formulae (1) and (2), the sample's sound absorbing power (ΔA) can be determined by the following formula.

$$Δ A = ( 55.3 V / c ) \times ( 1 / T 1 - 1 / T 2 )$$

When the area of the sample is denoted by S, the sound absorption coefficient by reverberation room method (a) can be determined by the following formula.

$$α = Δ A / S = ( 55.3 V / cS ) \times ( 1 / T 1 - 1 / T 2 )$$

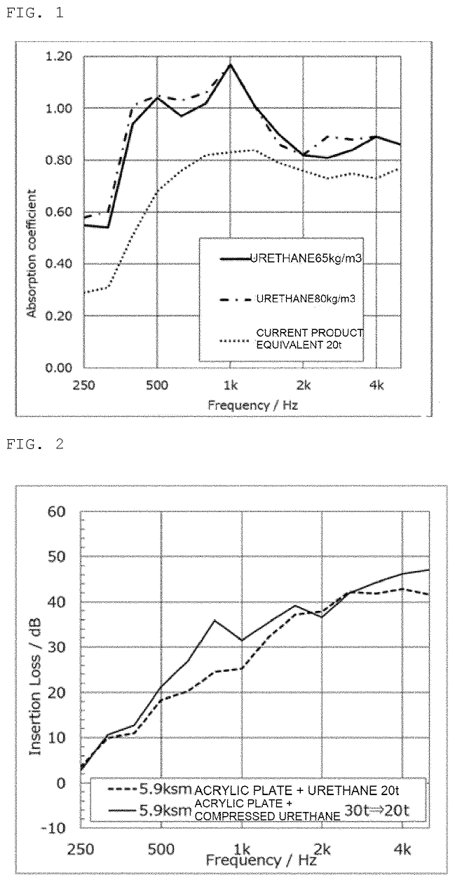

A sound absorption performance test was performed for an automotive soundproofing material made of a urethane foam material having a density of 65 Kg/m³ and a thickness of 35 mm (urethane 65 Kg/m³) and an automotive soundproofing material made of a urethane foam material having a density of 80 Kg/m³ and a thickness of 35 mm (urethane 80 Kg/m³), and as a comparative example, an automotive soundproofing material made of a two-layer felt having a thickness of 20 mm corresponding to a current product (current product equivalent 20t). The test results are shown in FIG. 1.

From the test results in FIG. 1, it was found that the automotive soundproofing material made of a urethane foam material of the invention has an excellent sound absorption coefficient of 0.80 or more at 400 Hz or more.

Then, it was found that in all the measured frequency bands, the automotive soundproofing material made of a urethane foam material of the invention has better sound absorption performance than the automotive soundproofing material made of a two-layer felt corresponding to a current product.

### Effect of Sound Insulation Performance due to Compression

The sound insulation performance was evaluated by placing a steel plate having a thickness of 0.8 mm in an opening of a sound source room and measuring the volume of sound transmitted through the opening.

Specifically, white noise was generated by a speaker in the sound source room, and a difference in sound pressure level between when a sample to be evaluated was placed on the steel plate in the opening and when it was not placed was taken, and the difference (insertion loss) was defined as the sound insulation performance of the sample to be evaluated.

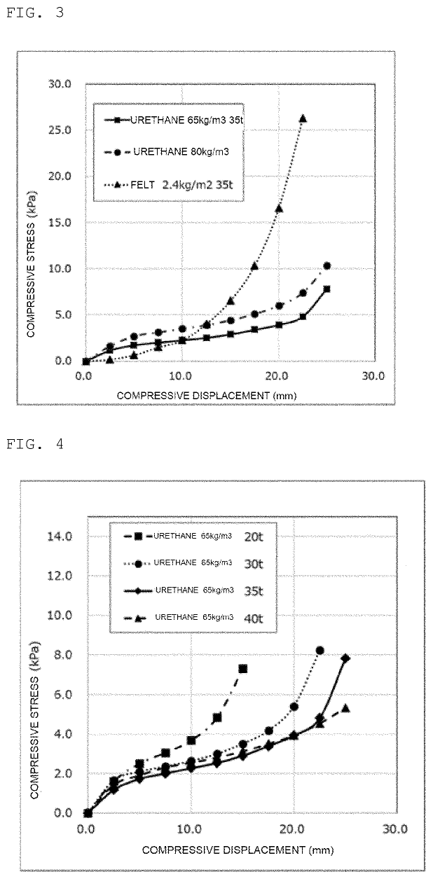

The sound insulation performance was measured for a sample in which an automotive soundproofing material made of a urethane foam material having a density of 65 Kg/m³ and a thickness of 20 mm and subsequently an acrylic plate having a density of 5.9 Kg/m² and a thickness of 5 mm were stacked on a steel plate having a thickness of 0.8 mm (5.9 ksm acrylic plate+urethane 20t) and a sample in which an automotive soundproofing material made of a urethane foam material obtained by compressing a urethane foam material having a density of 65 Kg/m³ and a thickness of 30 mm to a thickness of 20 mm, and subsequently an acrylic plate having a density of 5.9 Kg/m² and a thickness of 5 mm were stacked on a steel plate having a thickness of 0.8 mm (5.9 ksm acrylic plate+compressed urethane 30t⇒20t). The measurement results are shown in FIG. 2.

From the measurement results in FIG. 2, it was found that by compressing the urethane foam material of the invention, the sound insulation performance is improved as compared with the uncompressed urethane foam material having the same thickness.

### Compressive Stress

A material to be measured was cut into a 300 mm square to form a sample, and pre-compression was repeated twice until the thickness decreased to 75% of the original thickness using a disk having a diameter of 200 mm. Thereafter, a force when the sample was compressed in 2.5 mm increments was measured and taken as a compressive reaction force.

A value obtained by dividing the compressive reaction force by the area of the disk used during compression was defined as a compressive stress at the compressive displacement point.

The compressive stress was measured for an automotive soundproofing material made of a urethane foam material having a density of 65 Kg/m³ and a thickness of 35 mm (urethane 65 Kg/m³ 35t) and an automotive soundproofing material made of a urethane foam material having a density of 80 Kg/m³ and a thickness of 35 mm (urethane 80 Kg/m³ 35t), and as a comparative example, an automotive soundproofing material made of a felt having a density of 2.4 Kg/m² and a thickness of 35 mm (felt 2.4 Kg/m² 35t). The measurement results are shown in FIG. 3.

From the measurement results in FIG. 3, it was found that in the automotive soundproofing material made of a urethane foam material of the invention, the compressive reaction force tends to increase as the density of the urethane foam material increases.

When the compressive displacement was small (about 12.5 mm or less), the automotive soundproofing material made of a felt (felt 2.4 Kg/m² 35t) used as the comparative example had a lower compressive stress than the automotive soundproofing material made of a urethane foam material of the invention, but thereafter, the compressive stress of the automotive soundproofing material made of a felt (felt 2.4 Kg/m² 35t) used as the comparative example increased exponentially, and was higher than that of the automotive soundproofing material made of a urethane foam material of the invention.

A clearance on the back side of the air conditioning unit (HVAC) depends on the vehicle in which it is installed, but it was found that, for example, when the compressive displacement was set to about 17 mm, the compressive stress of the automotive soundproofing material made of a felt used as the comparative example becomes several times higher than that of the automotive soundproofing material made of a urethane foam material of the invention, and the compressive stress is as high as more than 10 KPa.

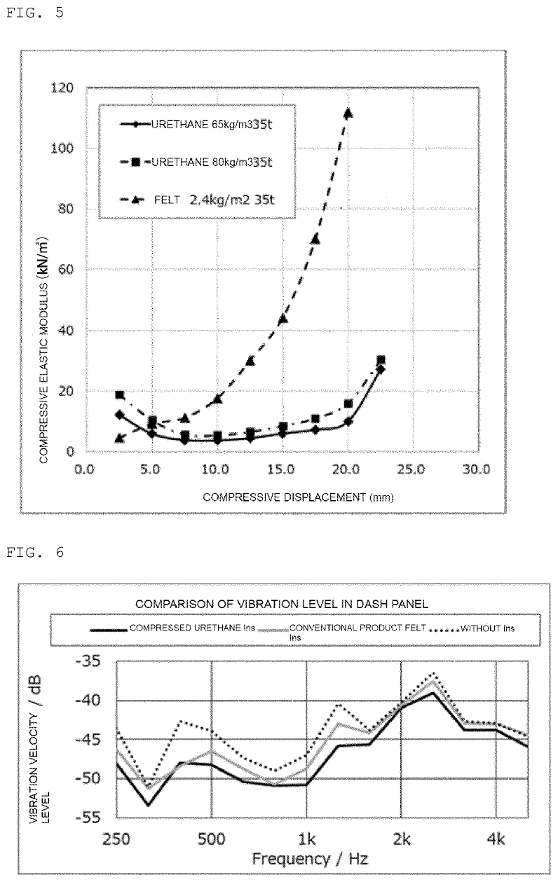

The compressive stress was measured for an automotive soundproofing material made of a urethane foam material having a density of 65 Kg/m³ and a thickness of 20 mm (urethane 65 Kg/m³ 20t), an automotive soundproofing material made of a urethane foam material having a density of 65 Kg/m³ and a thickness of 30 mm (urethane 65 Kg/m³ 30t), an automotive soundproofing material made of a urethane foam material having a density of 65 Kg/m³ and a thickness of 35 mm (urethane 65 Kg/m³ 35t), and an automotive soundproofing material made of a urethane foam material having a density of 65 Kg/m³ and a thickness of 40 mm (urethane 65 Kg/m³ 40t). The measurement results are shown in FIG. 4.

From the measurement results in FIG. 4, it was found that in the automotive soundproofing material made of a urethane foam material of the invention, the thinner the thickness before compression is, the earlier the increase in compressive stress starts, and the compressive stress with respect to the compressive displacement (mm) tends to increase.

Then, it was found that when the compressive displacement (mm) exceeds 50% of the thickness before compression, the compressive stress tends to rapidly increase.

### Compressive Elastic Modulus

A value obtained by dividing the amount of change in compressive reaction force determined using the measured compressive reaction force by the amount of change in compressive displacement (strain) was defined as a compressive elastic modulus.

The compressive stress was measured for an automotive soundproofing material made of a urethane foam material having a density of 65 Kg/m³ and a thickness of 35 mm (urethane 65 Kg/m³ 35t) and an automotive soundproofing material made of a urethane foam material having a density of 80 Kg/m³ and a thickness of 35 mm (urethane 80 Kg/m³ 35t), and as a comparative example, an automotive soundproofing material made of a felt having a density of 2.4 Kg/m² and a thickness of 35 mm (felt 2.4 Kg/m² 35t), and the compressive elastic modulus was determined. The results are shown in FIG. 5.

From the results in FIG. 5, it was found that in the automotive soundproofing material made of a urethane foam material of the invention, the compressive elastic modulus once decreases by compression (compressive displacement: up to about 7.5 mm), and thereafter shows a substantially constant value, but the compressive elastic modulus tends to rapidly increase by further compression (compressive displacement: more than 17.5 mm).

It was found that the automotive soundproofing material made of a felt (felt 2.4 Kg/m² 35t) used as the comparative example exhibits a lower compressive elastic modulus than the automotive soundproofing material made of a urethane foam material of the invention up to a compressive displacement of about 5.0 mm, but thereafter, the compressive elastic modulus tends to rapidly increase.

### Excitation Test

Impact excitation was applied with a hammer to a dash panel from an engine room side using a vehicle cut body.

The response of an accelerometer placed in a dash panel and an air conditioning unit (HVAC) was measured and evaluated in vibration velocity levels normalized by the excitation force with the hammer.

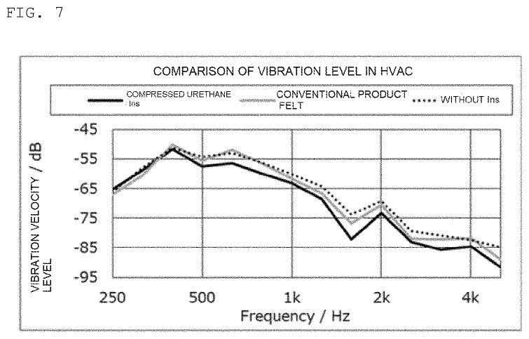

The response of an accelerometer placed inside a vehicle cabin in a dash panel was measured for a case where an automotive soundproofing material made of a urethane foam material of the invention was installed in the dash panel, and an air conditioning unit (HVAC) was installed while compressing the automotive soundproofing material (compressed urethane Ins), and as a comparative example, a case where an automotive soundproofing material made of a felt being a conventional product was installed in the dash panel, and an air conditioning unit (HVAC) was installed in a conventional manner (conventional product felt Ins), and a case where an air conditioning unit (HVAC) was installed without installing an automotive soundproofing material in the dash panel (without Ins). The test results are shown in FIG. 6.

As shown in FIG. 6, it was found that the vibration velocity level inside the vehicle cabin in the dash panel was reduced by installation while compressing the automotive soundproofing material made of a urethane foam material of the invention.

The response of an accelerometer placed in an air conditioning unit (HVAC) was measured for a case where an automotive soundproofing material made of a urethane foam material of the invention was installed in a dash panel, and the air conditioning unit (HVAC) was installed while compressing the automotive soundproofing material (compressed urethane Ins), and as a comparative example, a case where an automotive soundproofing material made of a felt being a conventional product was installed in a dash panel, and the air conditioning unit (HVAC) was installed in a conventional manner (conventional product felt Ins), and a case where the air conditioning unit (HVAC) was installed without installing an automotive soundproofing material in a dash panel (without Ins). The test results are shown in FIG. 7.

As shown in FIG. 7, it was found that the vibration velocity level in the air conditioning unit (HVAC) was reduced by installation while compressing the automotive soundproofing material made of a urethane foam material of the invention.

### INDUSTRIAL APPLICABILITY

With the use of the automotive soundproofing material made of a urethane foam material of the invention for a dash insulator, a soundproofing material having a soundproofing property equal or superior to that of a conventional one against sound including noise arising from vibration generated by a panel (dash panel) that separates the inside and outside of a vehicle cabin or an automotive component such as an air conditioning unit (HVAC) and penetrating into the vehicle cabin is realized by means of a simple structure, and an excellent soundproofing property can be realized in a method for attaching an automotive component using the soundproofing material.

1. An automotive soundproofing material comprising a urethane foam material, characterized in that the urethane foam material has a single-layer structure, the urethane foam material is configured to have either a uniform thickness or an increased thickness only in a region where it is needed, and an automotive component can be installed while compressing the urethane foam material.

2. The automotive soundproofing material according to claim 1, characterized in that by compressing the urethane foam material while installing the automotive component, an elastic modulus of the urethane foam material is reduced and sound insulation performance is improved.

3. The automotive soundproofing material according to claim 1, characterized in that the thickness of the urethane foam material is compressed within a range where a compression ratio is 10% or more and 50% or less.

4. The automotive soundproofing material according to claim 1, characterized in that only a portion where the automotive component is installed is compressed.

5. The automotive soundproofing material according to claim 1, characterized in that sound absorption performance at low frequencies is improved.

6. The automotive soundproofing material according to claim 1, characterized in that vibration damping performance is improved and radiated sound is reduced.

7. The automotive soundproofing material according to claim 1, characterized in that sound leaking from a hole or a gap for allowing a wire of the automotive component or a pipe to pass therethrough can be blocked by compressing the urethane foam material when the automotive component is installed.

8. The automotive soundproofing material according to claim 1, characterized in that the urethane foam material has a density of 40 to 120 Kg/m³ and a compressive stress of 1 to 10 KPa.

9. A method for attaching an automotive component, characterized in that after an automotive soundproofing material made of a urethane foam material is installed in a panel that separates inside and outside of a vehicle cabin, an automotive component installation portion of the urethane foam material is compressed, and thereafter, an automotive component is installed while being in close contact with (compressed against) the urethane foam material.

10. A method for attaching an automotive component, characterized in that an automotive soundproofing material made of a urethane foam material is installed in a panel that separates inside and outside of a vehicle cabin, and subsequently, an automotive component is installed while compressing the urethane foam material by the automotive component.

11. The method for attaching an automotive component according to claim 9, characterized in that the urethane foam material has a single-layer structure, and is configured to have either a uniform thickness or an increased thickness only in a region where it is needed.

12. The method for attaching an automotive component according to claim 9, characterized in that the panel that separates inside and outside of a vehicle cabin and the automotive soundproofing material made of the urethane foam material are in close contact with each other, and the automotive soundproofing material made of the urethane foam material and the automotive component when the automotive component is installed are in close contact with each other.

13. The method for attaching an automotive component according to claim 9, characterized in that sound insulation performance is improved.
